(19) United States
(12) Patent Application Publication
(10) Pub. No.: US 2012/0306843 A1
(43) Pub. Date: Dec. 6, 2012

(54) PIXEL CIRCUIT

(75) Inventors: Wen-Chun Wang, Taichung City (TW); Wen-Tui Liao, Taichung City (TW); Tsung-Yu Wang, Taichung City (TW); Chih-Hung Huang, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/484,203

(22) Filed: May 30, 2012

(30) Foreign Application Priority Data
Jun. 1, 2011 (TW) 100119289

(51) Int. Cl. G09G 5/00; G09G 3/30

(52) U.S. Cl. 345/212; 345/76

(57) ABSTRACT

A pixel circuit comprises a driving transistor, an electroluminescent unit, a pre-write unit, and a write unit. The electroluminescent unit is controlled by the driving transistor to illuminate in a drive period. The write unit is enabled in a write period recording a data voltage relating to an initial threshold voltage of the electroluminescent unit in first storage element. The pre-write unit is enabled in a pre-write period recording a threshold voltage of the driving transistor and the electroluminescent unit in second storage element. The threshold voltage and the data voltage, stored in the first and the second storage units, are supplied as a gate-source voltage of the driving transistor, so as to provide a compensated drive voltage, capable of compensating the variation of the threshold voltages of the driving transistor and the electroluminescent unit, driving the electroluminescent unit.

This application claims the benefit of Taiwan application Serial No. 100119289, filed Jun. 1, 2011, the subject matter of which is incorporated herein by reference.

### BACKGROUND OF THE INVENTION

1. Field of the Invention

The invention relates in general to a pixel circuit, and more particularly to a pixel circuit capable of compensating the variation of the threshold voltages of the driving transistor and the electroluminescent unit.

2. Description of the Related Art

With the rapid advance in technology, the organic light emitting diode (OLED) technology has been developed and used in various display applications such as TV, computer screen, notebook computer, mobile phone and PDA. In general, the OLED display comprises a plurality of OLED pixel structures arranged in the form of a matrix, and each OLED pixel structure comprises an OLED element and a corresponding driving circuit.

In general, the OLED element and driving circuit of the OLED display need to be turned on for a long duration for displaying images. However, the threshold turn-on voltage of the OLED element and the driving circuit will increase due to the stress effect if the OLED element and the driving circuit are turned on for a long duration. Consequently, the lifespan of the OLED display will be severely affected if the threshold turn-on voltage is increased. Therefore, how to provide an OLED pixel structure effectively compensating the threshold turn-on voltages of the OLED element and the driving circuit, which increase due to the stress effect, has become a prominent task for the industries.

### SUMMARY OF THE INVENTION

The invention is directed to a pixel circuit comprising an electroluminescent unit and a driving transistor thereof. The pixel circuit directed to by the invention comprises a write unit, a pre-write unit, and a loop transistor. The write unit records a data voltage relating to an initial threshold turn-on voltage of the electroluminescent element to a first storage element. The pre-write unit records the threshold voltages of the driving transistor and the electroluminescent unit to a second storage element. The loop transistor provides a compensated drive voltage according to the threshold voltage and the data voltage for enabling the driving transistor to drive the electroluminescent unit. The compensated drive voltage compensates the variation of the threshold voltages of the driving transistor and the electroluminescent unit. Thus, in comparison to the conventional electroluminescent device technology, the pixel circuit directed to by the invention has the advantage of compensating the variation of the threshold voltages of the driving transistor and the electroluminescent unit.

According to one embodiment of the present invention, a pixel circuit comprising a driving transistor, an electroluminescent unit, a pre-write unit and a write unit is provided. The driving transistor comprises a control end, a first connection end and a second connection end. The electroluminescent unit, coupled to the first connection end of the driving transistor, is controlled by the driving transistor to illuminate in a drive period. The write unit, coupled to the driving transistor, comprises a first storage element. The write unit is enabled in a write period to record the data voltage to the part between the first and the second ends of the first storage element, wherein the data voltage relates to an initial threshold turn-on voltage of the electroluminescent unit. The pre-write unit, coupled to the control end of the driving transistor and the write unit, comprises a second storage element. The pre-write unit is enabled in a pre-write period to record the threshold voltages of the driving transistor and the electroluminescent unit to the part between the first and the second ends of the second storage element. The data voltage and the threshold voltage, stored in the first and the second storage elements, are supplied to the part between the control end and the first connection end of the driving transistor, so as to provide a compensated drive voltage for enabling the driving transistor to drive the electroluminescent unit. The compensated drive voltage compensates the variation of the threshold voltages of the driving transistor and the electroluminescent unit.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a display using a pixel circuit according to one embodiment of the invention;

FIG. 2 shows a block diagram of a pixel circuit P (i,j);

FIG. 3 shows a detailed circuit diagram of a pixel circuit according to a first embodiment of the invention;

FIG. 4 shows a signal timing sequence diagram relating to the pixel circuit 100 of FIG. 3;

FIG. 5 shows another detailed circuit diagram of a pixel circuit according to a first embodiment of the invention;

FIG. 6 shows an alternate detailed circuit diagram of a pixel circuit according to a first embodiment of the invention;

FIG. 7 shows a detailed circuit diagram of a pixel circuit according to a second embodiment of the invention;

FIG. 8 shows a signal timing sequence diagram relating to the pixel circuit 120 of FIG. 7;

FIG. 9 shows a detailed circuit diagram of a pixel circuit according to a third embodiment of the invention;

FIG. 10 shows a signal timing sequence diagram relating to the pixel circuit 130 of FIG. 9;

FIG. 11 shows a detailed circuit diagram of a pixel circuit according to a fourth embodiment of the invention;

FIG. 12 shows a signal timing sequence diagram relating to the pixel circuit 200 of FIG. 11;

FIG. 13 shows an alternate detailed circuit diagram of a pixel circuit according to a fourth embodiment of the invention;

FIG. 14 shows a detailed circuit diagram of a pixel circuit according to a fifth embodiment of the invention;

FIG. 15 shows a signal timing sequence diagram relating to the pixel circuit 220 of FIG. 14;

FIG. 16 shows a detailed circuit diagram of a pixel circuit according to a sixth embodiment of the invention;

FIG. 17 shows a signal timing sequence diagram relating to the pixel circuit 230 of FIG. 16;

FIG. 18 shows a detailed circuit diagram of a pixel circuit according to a of the invention seventh embodiment;

FIG. 19 shows a signal timing sequence diagram relating to the pixel circuit 300 of FIG. 18;

FIG. 20 shows a detailed circuit diagram of a pixel circuit according to an eighth embodiment of the invention;

FIG. 21 shows a signal timing sequence diagram relating to the pixel circuit 400 of FIG. 20;

FIG. 22 shows a detailed circuit diagram of an pixel circuit according to a ninth embodiment of the invention;

FIG. 23 shows a signal timing sequence diagram relating to the pixel circuit 410 of FIG. 22;

FIG. 24 shows a detailed circuit diagram of an pixel circuit according to a tenth embodiment of the invention; and

FIG. 25 shows a signal timing sequence diagram relating to the pixel circuit 420 of FIG. 24.

### DETAILED DESCRIPTION OF THE INVENTION

The pixel circuit of the invention comprises a write unit, a pre-write unit and a loop transistor. The write unit records a data voltage relating to an initial threshold turn-on voltage of the electroluminescent element to a first storage element. The pre-write unit records the threshold voltages of the driving transistor and the electroluminescent unit to a second storage element. The loop transistor provides a compensated drive voltage according to the threshold voltage and the data voltage for enabling the driving transistor to drive the electroluminescent unit. The compensated drive voltage compensates the variation of the threshold voltage of the driving transistor and the electroluminescent unit.

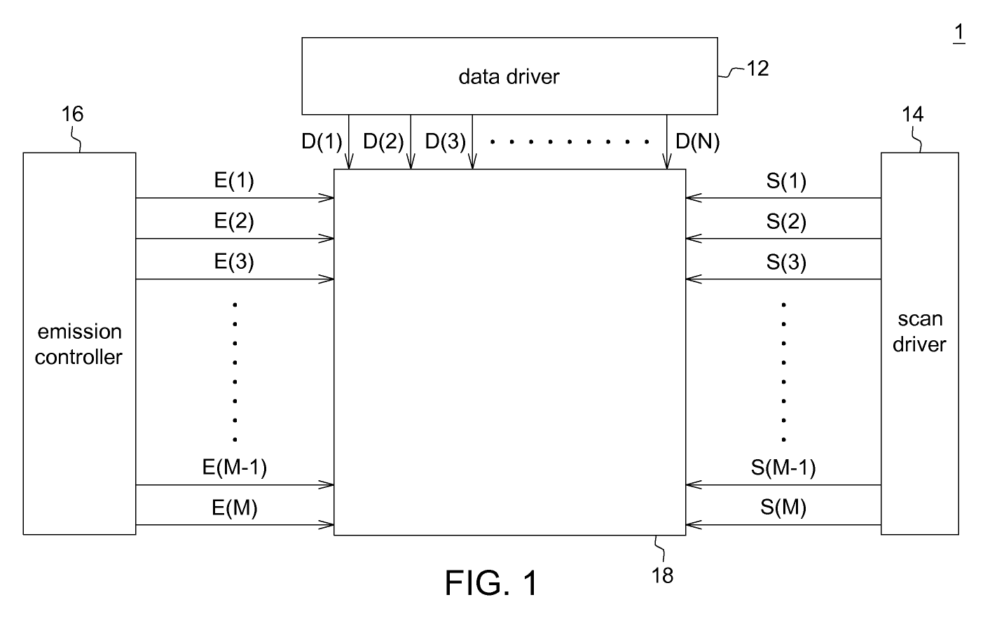

Referring to FIG. 1, a block diagram of a display using a pixel circuit according to one embodiment of the invention is provided. For example, the display 1 comprises a data driver 12, a scan driver 14, an emission controller 16 and a display panel 18. The display panel 18 comprises a pixel array having M×N pixel circuits P (1,1)˜P (M,N), wherein M and N both are a natural number larger than 1. The data driver 12, the scan driver 14 and the emission controller 16 respectively provide data signals D (1)˜D (N), scanning signals S (1)˜S (M) and emission signals E (1)˜E (M) to the display panel 18 for driving each of the pixel circuits P (1,1)˜P (M,N) to display frames.

Since the circuits and operations of the pixel circuits P (1,1)˜P (M,N) of the display panel 18 are substantially the same, one singe pixel circuit P (i,j) of the display panel 18 is used as an exemplification for elaborating the circuits and operations of the pixel circuits P (1,1)˜P (M,N) of the display panel 18, wherein i is a natural number smaller than or equal to M, and j is a natural number smaller than or equal to N.

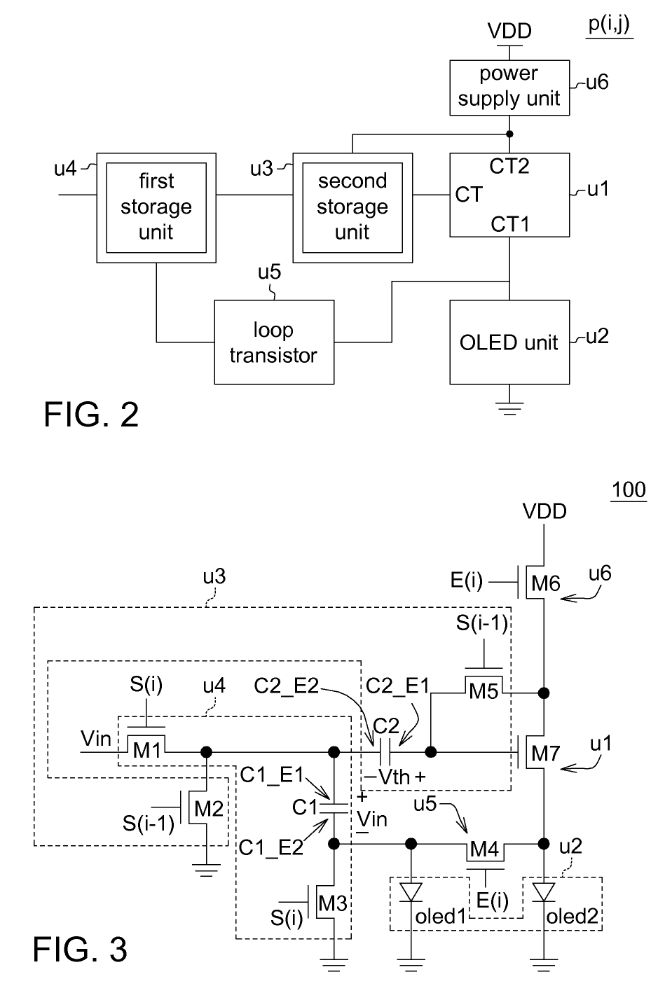

Referring to FIG. 2, a block diagram of a pixel circuit P (i,j) is provided. For example, the pixel circuit P (i,j) comprises a driving transistor u1, an electroluminescent unit (wherein OLED unit u2 shown in FIG. 2 is an exemplified electroluminescent unit but it is not limited thereto. The electroluminescent unit can also be selected from light emitting diode(LED) or the like.), a pre-write unit u3, a write unit u4, a loop transistor u5 and a power supply unit u6. The driving transistor u1 comprises a control end CT, a first connection end CT1 and a second connection end CT2. The OLED unit u2, coupled to the first connection end CT1 of the driving transistor u1, is controlled by the driving transistor u1 to illuminate in a drive period. In one embodiment, the OLED unit u2 is further controlled by the driving transistor u1 to illuminate in a pre-charge period.

The write unit u4 is coupled to the pre-write unit u3 and the loop transistor u5. The write unit u4 further comprises a first storage element, and is coupled to a data line (not illustrated) and enabled in a write period, so as to record a data voltage Vin to the first storage element.

The pre-write unit u3, coupled to the driving transistor u1 and the write unit u4, comprises a second storage element. The pre-write unit u3 is enabled in a pre-write period, so as to record a threshold voltage Vth of the driving transistor u1 and the OLED unit u2 to the second storage element.

The loop transistor u5 is connected between the write unit u4 and the first connection end CT1 of the driving transistor u1. The loop transistor u5 provides the threshold voltage Vth and the data voltage Vin, which are stored in the first and the second storage element, to the part between the control end CT and the first connection end CT1 of the driving transistor u1, so as to provide a compensated drive voltage Vcomp for enabling the driving transistor u1 to drive the OLED unit u2. The compensated drive voltage Vcomp compensates the variation of the threshold turn-on voltages of the driving transistor u1 and the OLED unit u2.

The power supply unit u6 is connected to the second connection end CT2 of the driving transistor u1 and the pre-write unit u3, wherein the power supply unit u6 supplies a high-potential reference voltage VDD to the driving transistor u1 in a drive period for enabling the driving transistor u1 to correspondingly drive the OLED unit u2. In one embodiment, the power supply unit u6 further supplies a high-potential reference voltage VDD to the driving transistor u1 and the second storage element of the pre-write unit u3 in a pre-charge period.

Each sub-unit of the OLED pixel circuit P (i,j) correspondingly has several implementations. A number of operation examples of the OLED pixel circuit P (i,j) are provided below for elaborating each sub-unit of the OLED pixel circuit P (i,j).

### First Embodiment

Referring to FIG. 3, a detailed circuit diagram of a Pixel circuit according to a first embodiment of the invention is provided. In the Pixel circuit 100 of the present embodiment of the invention, the driving transistor u1 is realized by a transistor M7, the OLED unit u2 comprises OLED elements oled1 and oled2, the write unit u4 comprises transistors M1 and M3 and a capacitor C1 used as a first storage element, the pre-write unit u3 comprises transistors M2 and M5 and a capacitor C2 used as a second storage element, the loop transistor u5 is realized by a transistor M4, and the power supply unit u6 is realized by a transistor M6.

Furthermore, the transistors M1˜M7 are realized by such as N-type metal oxide semiconductor (MOS) transistors. Of the transistor M2, the gate receives a previous-stage scanning signal S (i−1), the drain is coupled to the second end C2_E2 of the capacitor C2, the source receives a low potential reference voltage VSS such as a ground reference voltage. Of the transistor M5, the gate receives a previous-stage scanning signal S (i−1), the drain is coupled to the drain of the transistor M7, and the source is coupled to the first end C2_E1 of the capacitor C2 and the gate of the transistor M7.

Of the transistor M1, the gate receives a current stage scan signal S (i), the source is coupled to the first end C1_E1 of the capacitor C1, and the drain is coupled to the data line for receiving a data voltage Vin relating to an initial threshold turn-on voltage VOLEDi of the OLED unit u2, that is, the threshold turn-on voltage when the OLED unit u2 is not affected by the stress effect. For example, the data voltage Vin satisfies the formula (1):

Vin=Vdata−VOLEDi (1)

Wherein, the designation Vdata denotes a data voltage, the designation VOLEDi denotes an initial threshold turn-on voltage of an OLED element (such as oled2) when the OLED unit u2 is not affected by stress effect.

Of the transistor M3, the gate receives a current stage scan signal S (i), the source receives a low potential reference voltage VSS, and the drain is coupled to the second end C1_E2 of the capacitor C1.

Of the transistor M4, the gate receives a current-stage emission signal E (i), the drain is coupled to the source of the NMOS transistor M7, and the source is coupled to the second end C1_E2 of the capacitor C1. The OLED unit u2 comprises two OLED elements oled1 and oled2, wherein the negative ends of the OLED elements oled1 and oled2 receive a low potential reference voltage VSS, and the positive ends are coupled to the source and the drain of the transistor M4 respectively.

Of the transistor M6, the gate receives an emission signal E (i), the drain receives a high-potential reference voltage VDD, and the source is coupled to the drain of the NMOS transistor M7. Of the transistor M6, the gate is controlled by the current-stage emission signal E (i) to be enabled so as to provide a high-potential reference voltage VDD for enabling the transistor M7 in a drive period Te. The transistor M6 pre-charges the capacitor C2 in a pre-charge period Tp (before the pre-write unit u3 records the operation of the threshold voltage Vth), so as to provide a pre-charge voltage Vpre to the part between the first end C2_E1 and the second end C2_E2.

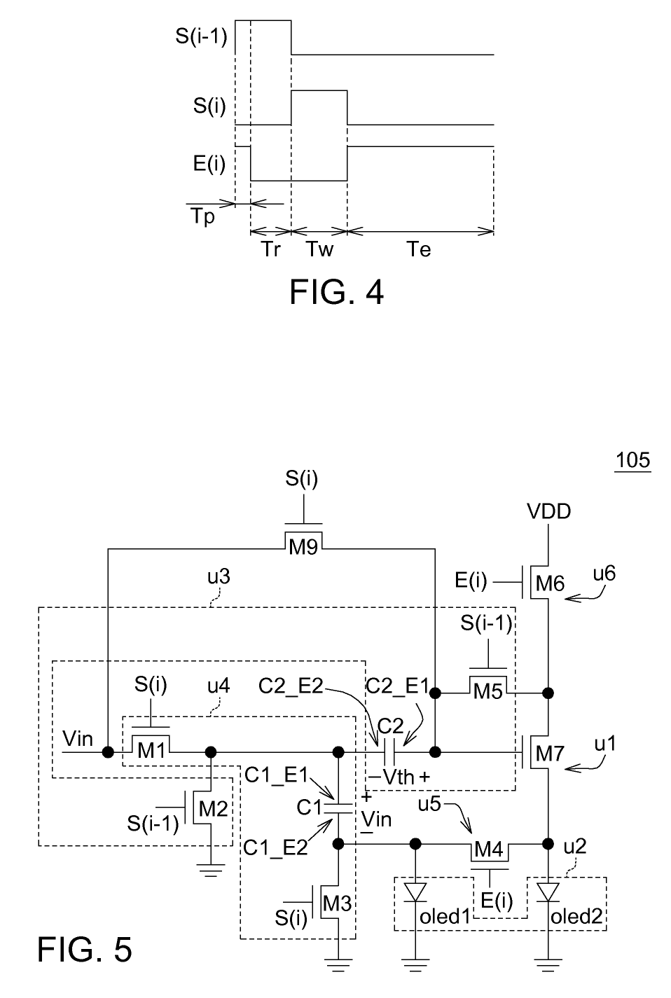

Referring to FIG. 4, a signal timing sequence diagram relating to the Pixel circuit 100 of FIG. 3 is provided. For example, the operation periods of the Pixel circuit 100 can be divided into a pre-charge period Tp, a pre-write period Tr, a write period Tw, and a drive period Te. The operations of the Pixel circuit 100 in each period are further elaborated below.

In the pre-charge period Tp, the previous-stage scanning signal S (i−1) and the current-stage emission signal E (i) are enabled, but the current stage scan signal S (i) is disabled. Thus, the transistors M1 and M3 are turned off, but the transistors M2, M4, M5, M6 and M7 are turned on, such that, in comparison to the second end C2_E2, the first end C2_E1 of the capacitor C2 has a pre-charge voltage Vpre, which satisfies the formula (2):

Vpre=VDD−VSS=VDD (2)

In the pre-write period Tr, the previous-stage scanning signal S (i−1) is enabled, but the current-stage emission signal E (i) and the current stage scan signal S (i) are disabled. Thus, the transistors M1, M3˜M4 and M6 are turned off, but the transistors M2, M5 and M7 are turned on, such that the voltage between the two ends of the capacitor C is discharged to the level of the threshold voltage Vth via a path comprising the transistors M5 and M7 and the OLED element oled2, wherein the threshold voltage Vth satisfies the formula (3):

Vth=VTh7+Voled2 (3)

Wherein designations Vth7 and Voled2 respectively denote the threshold turn-on voltages of the transistor M7 and the OLED element oled2. In other words, the capacitor C2 records the sum of the threshold turn-on voltages of the transistor M7 and the OLED element oled2.

In the write period Tw, the current stage scan signal S (i) is enabled, but the previous-stage scanning signal S (i−1) and the current-stage emission signal E (i) are disabled. Thus, the transistors M2 and M4˜M6 are turned off, but the transistors M1, M3 and M7 are turned on, such that the two ends of the capacitor C1 are charged to the level of the data voltage Vin, which satisfies the formula (4):

Vin=Vdata−VOLEDi (4)

In the drive period Te, the current-stage scanning signal S (i) and the previous-stage scanning signal S (i−1) are disabled, but the current-stage emission signal E (i) is enabled. Thus, the transistors M1˜M3 and M5 are turned off, but the transistors M4, M6, and M7 are turned on, so as to apply the cross-voltage crossing over the first end C2_E1 of the capacitor C2 and the second end C1_E2 of the capacitor C1 (that is, the sum of the threshold voltage Vth and the data voltage Vin) to the part between the gate and the source of the transistor M7, wherein the gate-source voltage Vgs7 of transistor M7 satisfies the formula (5):

Vgs7=Vth+Vin=Vth7+Voled2+Vdata−VOLEDi (5)

Since the gate-source voltage Vgs7 of the transistor M7 can be expressed as the formula (5), with reference to the formulas (3)˜(5), the current I flowing through the source of the transistor M7 (that is, the driving current flowing through the OLED unit u2) satisfies the formula (6):

I=k(Vgs7−Vth7)²=k[(Vth7+Voled2+Vdata−VOLEDi)−Vth7]²=k(Vdata+Voled2−VOLEDi)² (6)

As indicated in the formula (6), the current flowing through the OLED unit u2 is not affected by the threshold turn-on voltage Vth7 of the transistor M7. Thus, despite the threshold turn-on voltage Vth7 of the transistor M7 increases due to the stress effect, the volume of the driving current I is still not affected. In other words, the Pixel circuit 100 of the present embodiment of the invention correspondingly compensates the variation of the threshold turn-on voltages of the driving transistor (that is, the transistor M7).

Also, based on the item (Voled2-VOLEDi) of the formula of the driving current I relating to the threshold turn-on voltage Voled2 of the OLED element oled2 and the initial threshold turn-on voltage VOLEDi, the user correspondingly obtains the variation of the threshold turn-on voltages of the OLED element oled2. Thus, the user compensates the variation of the threshold turn-on voltages of the OLED element oled2 by adjusting the data voltage Vdata. For example, the data voltage Vdata is increased by an increment of (Voled2-VOLEDi). In an example, the write voltage of the data voltage Vdata ranges between 0-6 V.

The above operation shows that the Pixel circuit 100 of the present embodiment of the invention effectively records the threshold voltage Vth, and the variation of the threshold turn-on voltages Vth7 and Voled2 of the driving transistor u1 (the transistor M7) and the OLED element oled2 through the operations in the pre-write period Tr.

In the present embodiment of the invention, the OLED pixel unit 100 is exemplified by the one illustrated in FIG. 3, but the OLED pixel unit of the present embodiment of the invention is not limited thereto. In another example, the OLED pixel unit, like the OLED pixel unit 105 of FIG. 5, further comprises a transistor M9 such as an NMOS transistor, wherein, the gate receives a current stage scan signal S (i), the drain receives a data voltage Vin, and the source is coupled to the first end C2_E1 of the capacitor C2. The transistor M9 is controlled by the current stage scan signal S (i) in a write period Tw, such that the level of the voltage at the first end C2_E1 of the capacitor C2 (that is, the gate voltage of the transistor M7) can follow the level of the data voltage Vin.

In an operation example, the OLED oled1 of the OLED unit u2 is used for displaying images, but the OLED element oled2 is used for measuring the threshold turn-on voltage not for displaying images. Furthermore, the OLED element oled2 is turned on in a pre-write period Tr for recording the threshold turn-on voltage Voled2. Since the variation of the threshold turn-on voltages of the OLED element oled2 is very close to that of the OLED element oled1, the Pixel circuit 100 of the present embodiment of the invention can obtain the variation of the threshold turn-on voltages of the OLED element oled1 by measuring the variation of the threshold turn-on voltages of the OLED element oled2. For example, the OLED element oled2 blocks the provided light with a black matrix layer such that the user will not see the blocked light. Thus, the OLED element oled2 will not illuminate in the three periods other than the drive period Te, lest the contrast of the display 1 might be affected by the aforementioned light and become deteriorated.

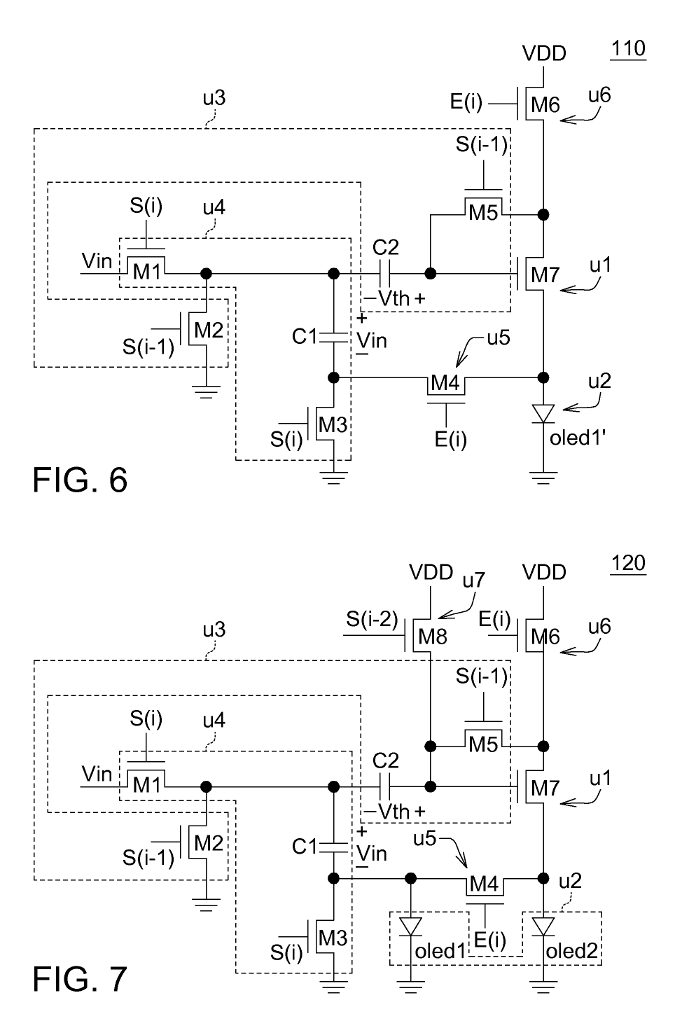

In other examples, the OLED unit u2 can have only one OLED element like the OLED pixel unit 110 of FIG. 6. In the present example, the OLED unit u2 has only one OLED element oled1′ possessing both the function of displaying images and the function of measuring the threshold turn-on voltage.

### Second Embodiment

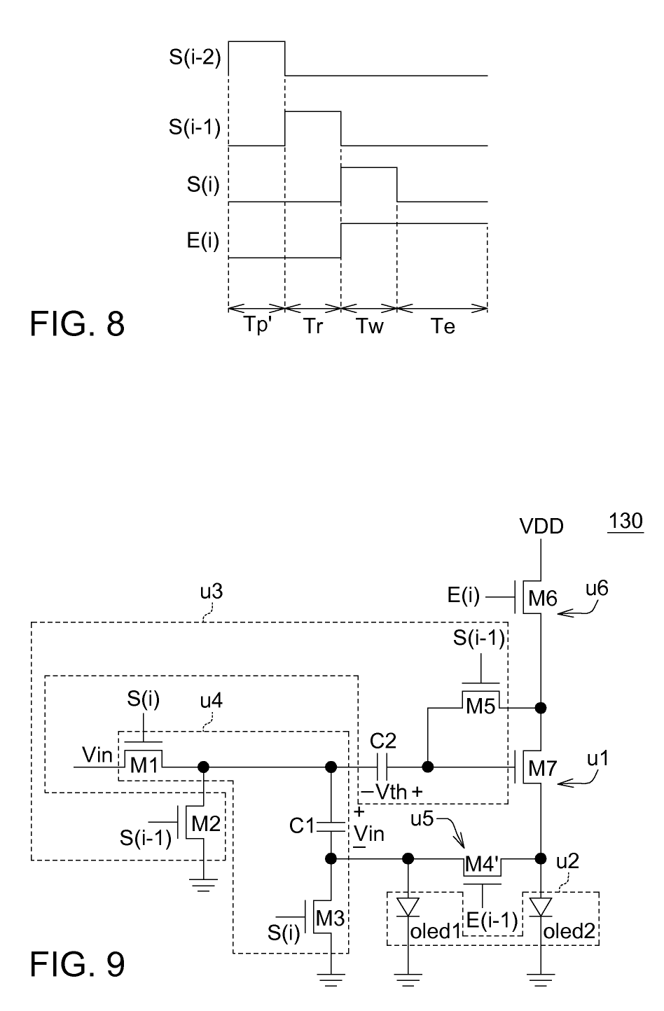

Referring to FIG. 7 and FIG. 8. FIG. 7 shows a detailed circuit diagram of a Pixel circuit according to a second embodiment of the invention. FIG. 8 shows a signal timing sequence diagram relating to the Pixel circuit 120 of FIG. 7. The Pixel circuit 120 of the present embodiment of the invention is different from the Pixel circuit 100 of the first embodiment in that the Pixel circuit 120 further comprises a pre-charge unit u7, which pre-charges the second storage element (that is, the capacitor C2) in a pre-charge period Tp′ before the pre-write unit u3 records the threshold voltage V, such that, in comparison to the second end C2_E2, the first end C2_E1 of the capacitor C2 has a pre-charge voltage Vpre.

For example, the pre-charge unit u7 is realized by a transistor M8 such as an NMOS transistor, wherein the gate receives a second-previous-stage scanning signal S (i−2), the source is coupled to the first end C2_E1 of the capacitor C2, and the drain receives a high-potential reference voltage VDD. Thus, the transistor M8 is controlled by the second-previous-stage scanning signal S (i−2) to be enabled in the pre-charge period Tp′, so as to provide the high-potential reference voltage VDD to the first end C2_E1 of the capacitor C2, such that the capacitor C2 records a pre-charge voltage Vpre corresponding to the high-potential reference voltage VDD.

The pre-charge period Tp′ of the present embodiment of the invention corresponds to the enable period of the second-previous-stage scanning signal S (i−2), while the pre-charge period Tp of the first embodiment corresponds to the enable period in which both the previous-stage scanning signal S (i−1) and the current-stage emission signal E (i) are enabled. In the pre-charge period Tp′ of the present embodiment of the invention, the current-stage emission signal E (i) is disabled, such that the OLED element oled1 is enabled in the drive period Te only and disabled in the pre-charge period Tp′, the pre-write period Tr and the write period Tw. Thus, the Pixel circuit 120 of the present embodiment of the invention effectively controls the OLED element oled1 to be enabled in the drive period Te only and be disabled in other periods, so as to enhance the contrast of the display 1.

Thus, like the Pixel circuit 100 of the first embodiment, the Pixel circuit 120 of the present embodiment of the invention correspondingly compensates the variation of the threshold turn-on voltages of the driving transistor (that is, the transistor M7) and the OLED element.

### Third Embodiment

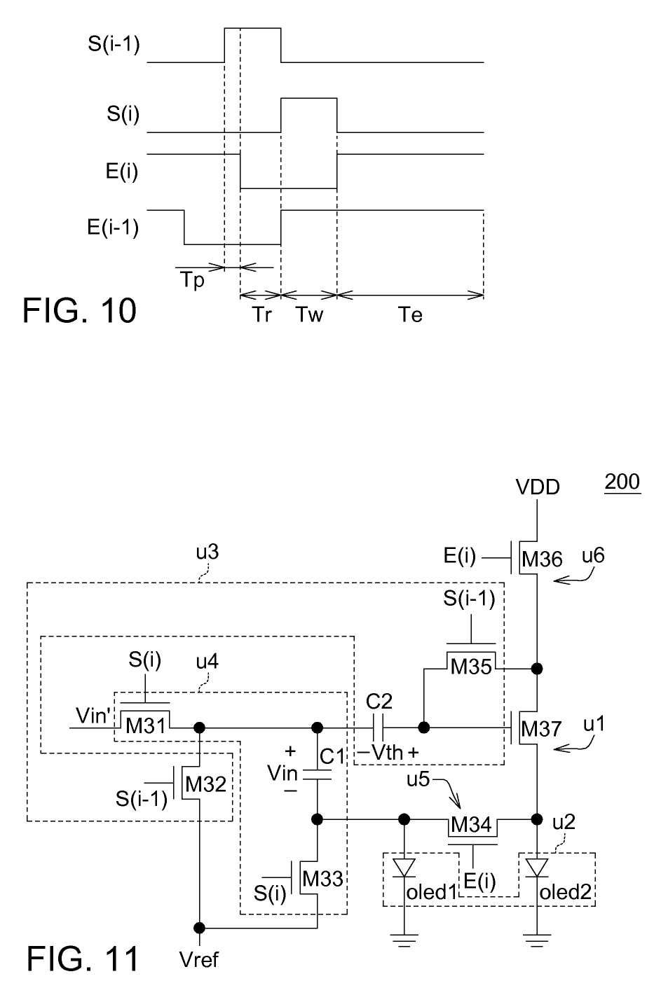

Referring to FIG. 9 and FIG. 10. FIG. 9 shows a detailed circuit diagram of a Pixel circuit according to a third embodiment of the invention. FIG. 10 shows a signal timing sequence diagram relating to the Pixel circuit 130 of FIG. 9. The Pixel circuit 130 of the present embodiment of the invention is different from the Pixel circuit 100 of the first embodiment in that the transistor M4′ of the loop transistor u5 receives a previous-stage emission signal E (i−1) instead of a current-stage emission signal E (i). In the pre-charge period Tp, the transistor M4′ is disabled in response to the previous-stage emission signal E (i−1) to avoid the current provided via the transistors M6 and M7 flowing to the OLED element oled1. Thus, the OLED element oled1 will not be driven to illuminate in the pre-charge period Tp and the contrast of the display 1 is enhanced. The operations of the Pixel circuit 130 of the present embodiment of the invention in each operation period are further elaborated below.

In the pre-charge period Tp, the previous-stage scanning signal S (i−1) and the current-stage emission signal E (i) are enabled, but the current stage scan signal S (i) and the previous-stage emission signal E (i−1) are disabled. Thus, the transistors M1, M3 and M4′ are turned off, but the transistors M2, M5, M6 and M7 are turned on, such that, in comparison to the second end C2_E2, the first end C2_E1 of the capacitor C2 has a pre-charge voltage Vpre, which satisfies the formula (7):

Vpre=VDD−VSS=VDD (7)

In the pre-write period Tr, the previous-stage scanning signal S (i−1) is enabled, but the current-stage emission signal E (i), the current stage scan signal S (i) and the previous-stage emission signal E (i−1) are disabled. Thus, the transistor M1, M3, M4′ and M6 are turned off, but the transistors M2, M5 and M7 are turned on, such that the voltages across the capacitor C2 are discharged to the level of the threshold voltage Vth via a path comprising the transistors M5, M7 and the OLED element oled2, wherein the threshold voltage Vth satisfies the formula (8):

Vth=VTh7+Voled2 (8)

Wherein, the designations Vth7 and Voled2 respectively denote the threshold turn-on voltages of the transistor M7 and the OLED element oled2. In other words, the capacitor C2 records the sum of the threshold turn-on voltages of the transistor M7 and the OLED element oled2.

In the write period Tw, the current stage scan signal S (i) and the previous-stage emission signal E (i−1) are enabled, but the previous-stage scanning signal S (i−1) and the current-stage emission signal E (i) are disabled. Thus, the transistors M2, M5 and M6 are turned off, but the transistors M1, M3, M4′ and M7 are turned on, such that the voltages across the capacitor C1 are charged to the level of the data voltage Vin, wherein the data voltage Vin such as satisfies the formula (9):

Vin=Vdata—VOLEDi (9)

In the drive period Te, the current stage and the previous-stage scanning signal S (i) and S (i−1) are disabled, but the current-stage emission signal E (i) and the previous-stage emission signal E (i−1) are enabled. Thus, the transistors M1˜M3 and M5 are turned off, but the transistors M4′, M6, M7 are turned on, so as to apply the cross-voltage crossing over the first end C2_E1 of the capacitor C2 and the second end C1_E2 of the capacitor C1 (that is, the sum of the threshold voltage Vth and the data voltage Vin) to the part between the gate and the source of the transistor M7, wherein the gate-source voltage Vgs7 of the transistor M7 satisfies the formula (10):

Vgs7=Vth+Vin=Vth7+Voled2+Vdata—VOLEDi (10)

Since the gate-source voltage Vgs7 of the transistor M7 can be expressed as the formula (10), with reference to the formulas (8)˜(10), the current I flowing through the source of the transistor M7 (that is, the driving current flowing through the OLED unit u2) satisfies the formula (11):

I=k(Vgs7−Vth7)²=k[(Vth7+Voled2+Vdata−VOLEDi)−Vth7]²=k(Vdata+Voled2−VOLEDi)² (11)

Thus, like the Pixel circuit 100 of the first embodiment, the Pixel circuit 130 of the present embodiment of the invention can also correspondingly compensate the variation of the threshold turn-on voltages of the driving transistor (that is, the transistor M7) and the OLED element.

### Fourth Embodiment

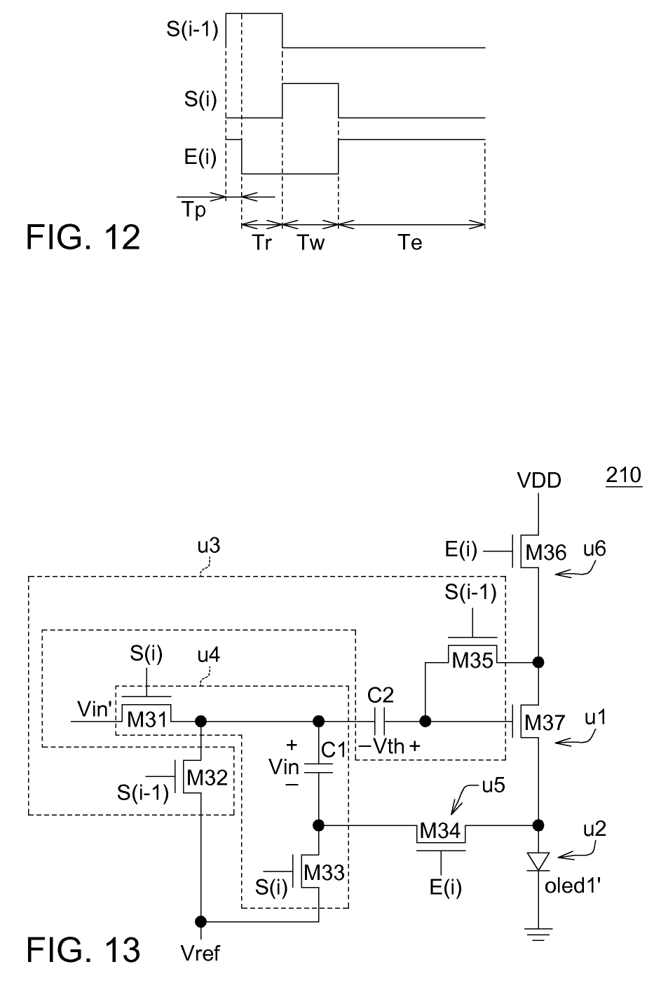

Referring to FIG. 11 and FIG. 12. FIG. 11 shows a detailed circuit diagram of a Pixel circuit according to a fourth embodiment of the invention. FIG. 12 shows a signal timing sequence diagram relating to the Pixel circuit 200 of FIG. 11. The Pixel circuit 200 of the present embodiment of the invention is different from the Pixel circuit 100 of the first embodiment in that the sources of the transistors M32 and M33 receive a reference voltage Vref instead of a low potential reference voltage VSS. Besides, the data voltage Vin′ inputted via the transistor M31 is equal to the data voltage Vdata but is not equal to the voltage difference (Vdata−VOLEDi) between the data voltage and the initial threshold turn-on voltage of the OLED unit u2. For example, the level of the reference voltage Vref satisfies:

Vref=½VOLEDi (12)

Wherein the designation VOLEDi denotes the threshold turn-on voltage when the OLED unit u2 is not affected by stress effect.

Thus, the pre-charge voltage V_pre across the capacitor C2 in the pre-charge period Tp, the threshold voltage Vth written to the two ends of the capacitor C2 in the pre-write period Tr, and the data voltage Vin written to the two ends of the capacitor C1 in the write period Tw respectively satisfy the formulas (13)˜(15):

Vpre=VDD−Vref (13)

Vth=VTh37+Voled2−Vref (14)

Vin=Vin′−Vref=Vdata−Vref (15)

Thus, the voltage Vgs37 applied to the part between the gate and the source of transistor M37 in the drive period Te satisfies the formula (16):

Vgs37=Vth+Vin=Vth37+Voled2+Vdata−2Vref (16)

With reference to the formulas (14)˜(16), the current I flowing through the source of the transistor M37 (that is, the driving current flowing through the OLED unit u2) satisfies the formula (17):

$$\begin{matrix}I = {k ( Vgs 37 - Vth 37 )}^{2} \\ = {k [ ( Vth 37 + Voled 2 + Vdata - 2 Vref ) - Vth 37 ]}^{2} \\ = {k [ ( Vth 37 + Voled 2 + Vdata - VOLEDi ) - Vth 37 ]}^{2} \\ = {k ( Vdata + Voled 2 - VOLEDi )}^{2}\end{matrix} \qquad ( 17 )$$

Thus, like the Pixel circuit 100 of the first embodiment, the Pixel circuit 200 of the present embodiment of the invention can also correspondingly compensate the variation of the threshold turn-on voltages of the driving transistor (that is, the transistor M37) and the OLED element.

Like the first embodiment, the OLED unit u2 can be realized by one OLED element oled1′ only as indicated in FIG. 13, and the operations of the OLED unit u2 can be obtained from the disclosure of the present embodiment of the invention and the corresponding disclosure of the first embodiment.

### FIFTH AND SIXTH EMBODIMENT

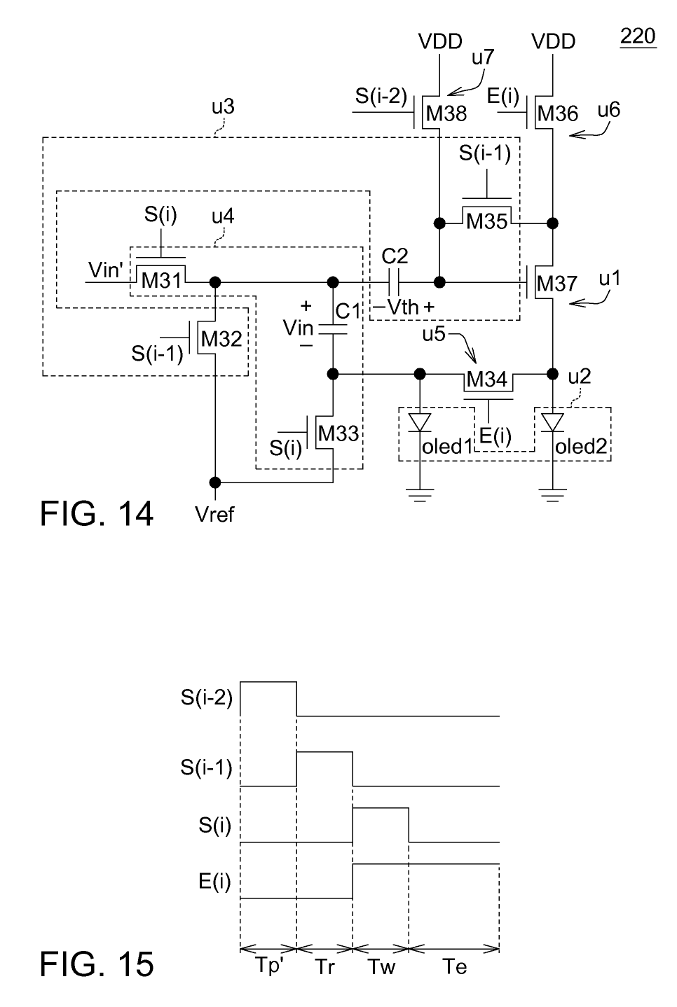

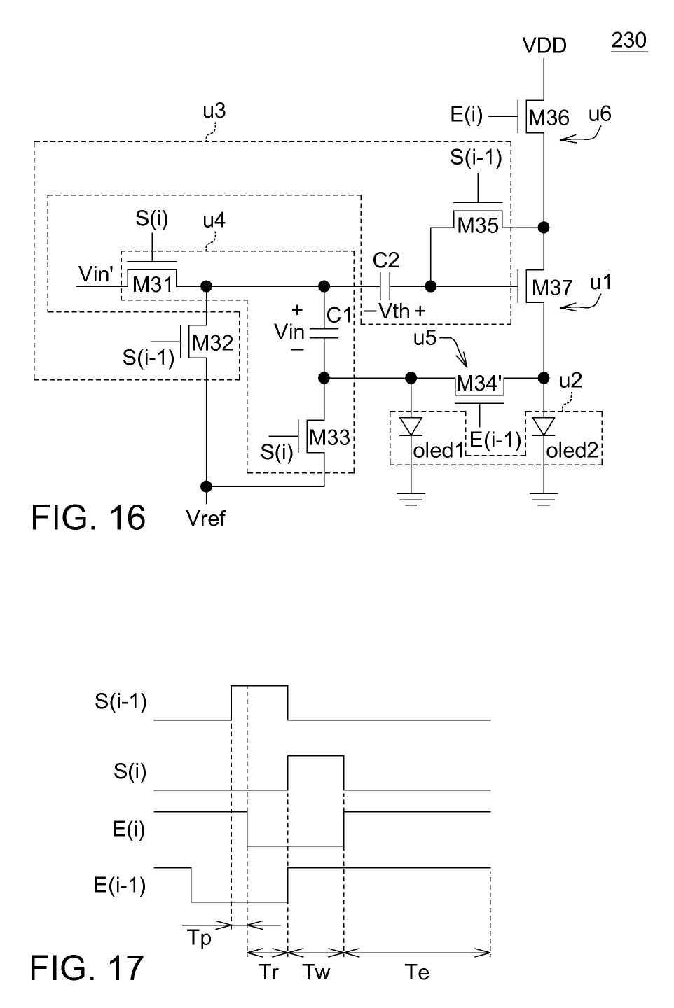

Referring to FIG. 14, FIG. 15, FIG. 16 and FIG. 17. FIG. 14 shows a detailed circuit diagram of a Pixel circuit according to a fifth embodiment of the invention. FIG. 15 shows a signal timing sequence diagram relating to the Pixel circuit 220 of FIG. 14. FIG. 16 shows a detailed circuit diagram of a Pixel circuit according to a sixth embodiment of the invention. FIG. 17 shows a signal timing sequence diagram relating to the Pixel circuit 230 of FIG. 16. Like the Pixel circuit 200 of the fourth embodiment, the Pixel circuits 220 and 230 of the fifth and the sixth embodiments are different from the Pixel circuits 120 and 130 of the second and the third embodiments in that the sources of the transistors M32 and M33 receive a reference voltage Vref instead of a receive low potential reference voltage VSS, and that the data voltage Vin′ inputted via the transistor M31 is equal to the data voltage Vdata but is not equal to the voltage difference (Vdata−VOLEDi) between the data voltage and the initial threshold turn-on voltage of the OLED unit u2.

Thus, like the Pixel circuit 200 of the fourth embodiment, the Pixel circuits 220 and 230 of the fifth and the sixth embodiments can also correspondingly compensate the variation of the threshold turn-on voltages of the driving transistor (that is, the transistor M37) and the OLED element.

### Seventh Embodiment

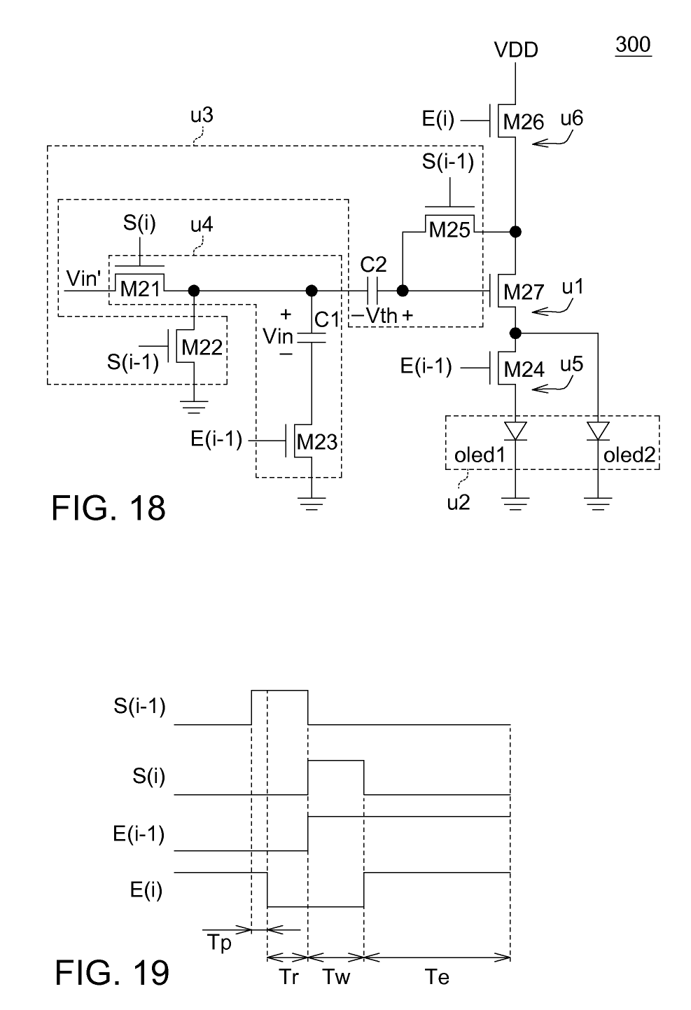

Referring to FIG. 18 and FIG. 19. FIG. 18 shows a detailed circuit diagram of a Pixel circuit according to a of the invention seventh embodiment. FIG. 19 shows a signal timing sequence diagram relating to the Pixel circuit 300 of FIG. 18. The Pixel circuit 300 of the present embodiment of the invention is different the Pixel circuit 200 of the fourth embodiment in that the sources of the transistors M22 and M23 receive a low potential reference voltage VSS, that the transistors M23 and M24 are controlled by the previous-stage emission signal E (i−1) to be selectively turned on so as to correspondingly apply the voltages across the capacitors c1 and c2 to the part between the gate and the source of the transistor M27, and that the loop transistor u5 and the OLED unit u2 have different relationships of circuit connection.

Specifically, of the loop transistor u5, the transistor M24 is such as an NMOS transistor, the gate receives a previous-stage emission signal E (i−1), the drain is coupled to the source of the transistor M27, and the source receive a low potential reference voltage VSS. In the OLED unit u2, the first end of the OLED element oled2 is coupled to the drain of the transistor M24 and the source of the transistor M27, and the second end of the OLED element oled2 receives a low potential reference voltage VSS. The first end of the OLED element oled1 is coupled to the source of the transistor M24, and the second end receives a low potential reference voltage VSS.

Since the waveform-patterns of the previous-stage emission signal E (i−1) and the current stage scan signal S (i) are substantially the same in the pre-charge period Tp, the pre-write period Tr, and the write period Tw, the operations of the Pixel circuit 300 of the present embodiment of the invention and the Pixel circuit 200 of the fourth embodiment are substantially the same in the said three periods. Thus, the pre-charge voltage V_pre across the capacitor C2 in the pre-charge period Tp, the threshold voltage Vth written to the two ends of the capacitor C2 in the pre-write period Tr, and the data voltage Vin at the two ends of the capacitor C1 in the write period Tw respectively satisfy the formula (18)˜(20):

Vpre=VDD−VSS=VDD (18)

Vth=VTh27+Voled2−VSS=VTh27+Voled2 (19)

Vin=Vin′−VSS=Vdata−VSS=Vdata (20)

In the drive period Te, the previous-stage emission signal E (i−1) corresponds to an enable level, such that the transistors M23 and M24 both are turned on, the cross-voltage crossing over the capacitors c1 and c2 is applied to the part between the gate and the source of the transistor M27. Thus, the gate-source voltage Vgs27 of the transistor M27 in the drive period Te satisfies the formula (21):

Vgs27=Vth+Vin=Vth27+Voled2+Vdata (21)

With reference to the formulas (19)˜(21), the current flowing through the source of the transistor M27 (that is, the driving current I flowing through the OLED unit u2) satisfies the formula (22):

I=k(Vgs27−Vth27)²=k[(Vth27+Voled2+Vdata)−Vth27]²=k(Vdata+Voled2)² (22)

Unlike the first to the sixth embodiments, the formula of the driving current I of the present embodiment of the invention does not have the item (Voled−VOLEDi), and can directly compensate the variation of the threshold turn-on voltages of the OLED element. However, the Pixel circuit 300 of the present embodiment of the invention can generate impedance variation due to the variation of the threshold turn-on voltage of the OLED element oled2, so as to change the discharging rate of the voltages across the capacitor C2 in the pre-write period Tr. Thus, the voltage level stored to the capacitor C2 in the pre-write period Tr is changed correspondingly in response to different threshold turn-on voltages of the OLED element oled2, so as to compensate the variation of the threshold turn-on voltages of the OLED element oled2.

Furthermore, when the stress effect has minor influence on the threshold turn-on voltage of the OLED element oled2, the OLED element oled2 correspondingly has a lower threshold turn-on voltage and lower impedance. Thus, the discharging path formed by the transistors M25 and M27, the OLED element oled2 and the transistor M22 correspondingly has lower impedance. Thus, in response to the above discharging path with lower impedance, the capacitor C2 has faster discharging rate in the pre-write period Tr, such that the threshold voltage Vth stored at the two ends of the capacitor C2 corresponds to a lower voltage level.

To the contrary, when the stress effect has severe influence on the threshold turn-on voltage of the OLED element oled2, the OLED element oled2 correspondingly has a higher threshold turn-on voltage and higher impedance, such that the discharging path formed by the transistors M25 and M27, the OLED element oled2 and the transistor M22 correspondingly has higher impedance. Thus, in response to the above discharging path with higher impedance, the capacitor C2 has slower discharging rate in the pre-write period Tr, such that the threshold voltage Vth stored across the capacitor C2 corresponds to a higher voltage level.

To summarize, when the OLED element oled2 corresponds to different threshold turn-on voltages, the Pixel circuit 300 of the present embodiment of the invention stores the threshold voltages Vth of different voltage levels to the two ends of the capacitor C2 in the pre-write period Tr, and correspondingly compensate the variation of the threshold turn-on voltages of the OLED element oled2.

Like the above embodiments, the Pixel circuit 300 of the present embodiment of the invention can also correspondingly compensate the variation of the threshold turn-on voltages of the driving transistor (that is, the transistor M27).

### Eighth Embodiment

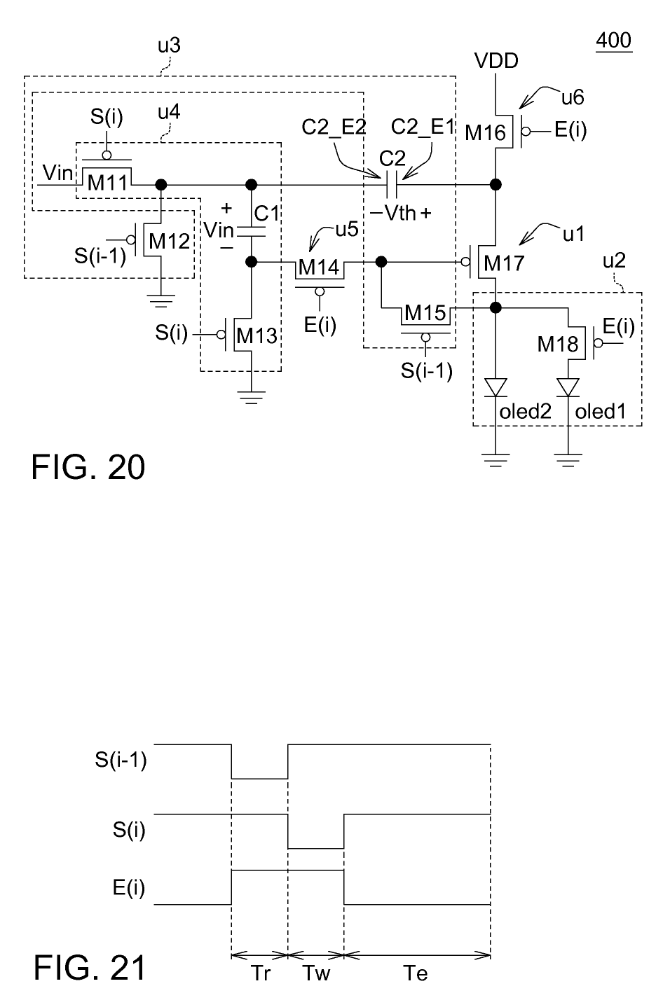

Referring to FIG. 20 and FIG. 21. FIG. 20 shows a detailed circuit diagram of a Pixel circuit according to an eighth embodiment of the invention. FIG. 21 shows a signal timing sequence diagram relating to the Pixel circuit 400 of FIG. 20. The Pixel circuit 400 of the present embodiment of the invention is different from the Pixel circuit 100 of the first embodiment in that the Pixel circuit 400 is realized by PMOS transistors M11˜M18, wherein the first end C2_E1 of the capacitor C2 is pre-biased to the high-potential reference voltage VDD in a previous drive period Te. Since the Pixel circuit 400 of the present embodiment of the invention does not require a pre-charge period, the operation periods are divided into a pre-write period Tr, a write period Tw and a drive period Te.

In the Pixel circuit 400 of the present embodiment of the invention, the coupling relationships for the loop transistor u5 and the OLED unit u2 are different. Specifically, the transistor M14 of the loop transistor u5 is realized by such as a PMOS transistor, wherein the gate receives a current-stage emission signal E (i), the source is coupled to the gate of the transistor M17 of the driving transistor u1, and the drain is coupled to the second end of the first storage element (that is, the second end C1_E2 of the capacitor C1). Thus, in response to the enabled current-stage emission signal E (i), the transistor M14 couples the second end C1_E2 of the capacitor C1 to the gate of the transistor M17 in a drive period Te, so as to provide the voltages stored in the capacitors C1 and C2 to the part between the gate and the source of the transistor M17.

In the Pixel circuit 400 of the present embodiment of the invention, the OLED unit u2 has different circuits. Specifically, the OLED unit u2 comprises OLED elements oled1, oled2 and a switch transistor M18. The first end of the OLED element oled2 is coupled to the drain of the transistor M17, the second end of the OLED element oled2 receives a low potential reference voltage VSS. Of the switch transistor M18, the gate receives a current-stage emission signal E (i), and the source is coupled to the drain of the transistor M17. Of the OLED element oled1, the first end is coupled to the source of the switch transistor M18, and the second end receives a low potential reference voltage VSS. Thus, the switch transistor M18 assures that the OLED element oled1 (that is, the OLED element actually used for illuminating) is enabled to illuminate in the drive period Te. The operations of the Pixel circuit 400 of the present embodiment of the invention in each operation period are elaborated below.

In the pre-write period Tr, the previous-stage scanning signal S (i−1) is enabled, but the current-stage emission signal E (i) and the current stage scan signal S (i) are disabled. Thus, the transistors M11, M13˜M14 and M16 are turned off, but the transistors M12, M15 and M17 are turned on, such that the voltage at the two ends of the capacitor C2 are discharged to the level of the threshold voltage Vth via a path comprising the transistors M15, M17 and the OLED element oled2, wherein the threshold voltage Vth satisfies the formula (23):

Vth=VTh17+Voled2 (23)

Wherein the designations Vth17 and Voled2 respectively denote the threshold turn-on voltages of the transistor M17 and the OLED element oled2. In other words, the capacitor C2 records the sum of the threshold turn-on voltages of the transistor M17 and the OLED element oled2.

In the write period Tw, the current stage scan signal S (i) is enabled, but the previous-stage scanning signal S (i−1) and the current-stage emission signal E (i) are disabled. Thus, the transistors M12 and M14˜M16 are turned off, but the transistors M11, M13 and M17 are turned on, such that the voltages across the capacitor C1 are charged to the level of the data voltage Vin, wherein the data voltage Vin such as satisfies the formula (24):

Vin=Vdata−VOLEDi (24)

In the drive period Te, the current stage and the previous-stage scanning signals S (i) and S (i−1) are disabled, but the current-stage emission signal E (i) is enabled. Thus, the transistors M11˜M13 and M15 are turned off, but the transistors M14, M16, M17 are turned on, so as to apply the cross-voltage crossing over the first end C2_E1 of the capacitor C2 and the second end C1_E2 of the capacitor C1 (that is, the sum of the threshold voltage Vth and the data voltage Vin) to the part between the gate and the source of the transistor M17, wherein the gate-source voltage Vgs17 of the transistor M17 satisfies the formula (25):

Vgs17=Vth+Vin=Vth17+Voled2+Vdata−VOLEDi (25)

Since the gate-source voltage Vgs17 of the transistor M17 can be expressed by the formula (25), with reference to the formulas (23)˜(25), the current I flowing through the source of the transistor M17 (that is, the driving current flowing through the OLED unit u2) satisfies the formula (26):

I=k(Vgs17−Vth17)²=k[(Vth17+Voled2+Vdata−VOLEDi)−Vth17]²=k(Vdata+Voled2−VOLEDi) (26)

Like the Pixel circuit of each of the above embodiments, the Pixel circuit 400 of the present embodiment of the invention can also correspondingly compensate the variation of the threshold turn-on voltages of the driving transistor (that is, the transistor M17) and the OLED element.

### Ninth Embodiment

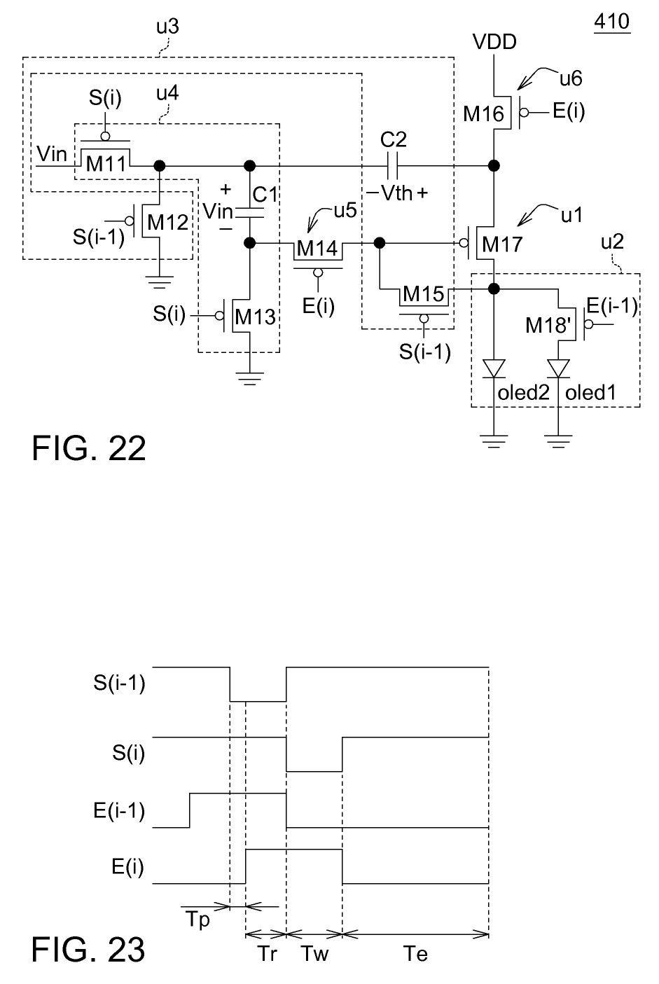

Referring to FIG. 22 and FIG. 23. FIG. 22 shows a detailed circuit diagram of a Pixel circuit according to a ninth embodiment of the invention.

FIG. 23 shows a signal timing sequence diagram relating to the Pixel circuit 410 of FIG. 22. The Pixel circuit 410 of the present embodiment of the invention is different from the Pixel circuit 400 of the eighth embodiment in that the gate of the switch transistor M18′ receives a previous-stage emission signal E (i−1), and that the time in which the previous-stage scanning signal S (i−1) and the current-stage emission signal E (i) are both enabled is defined as a pre-charge period Tp.

Like the Pixel circuit 400 of the eighth embodiment, the Pixel circuit 410 of the present embodiment of the invention can also correspondingly compensate the variation of the threshold turn-on voltages of the driving transistor (that is, the transistor M17) and the OLED element.

### Tenth Embodiment

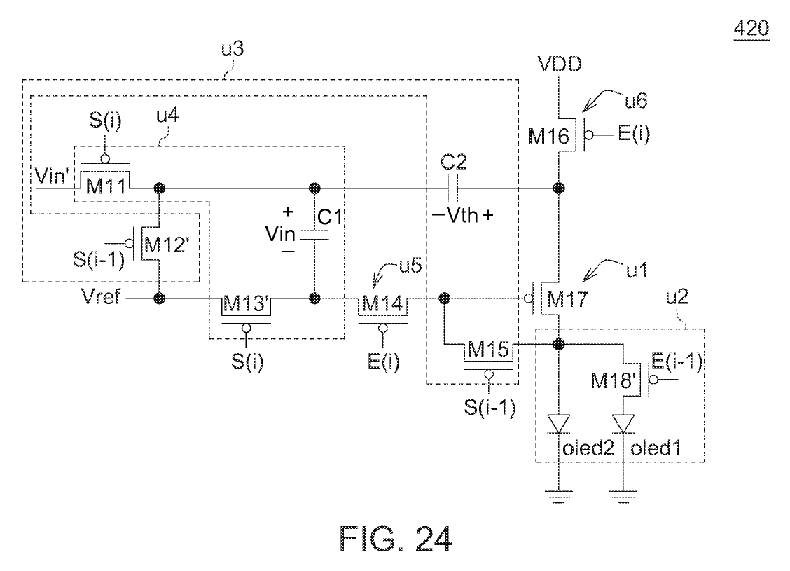

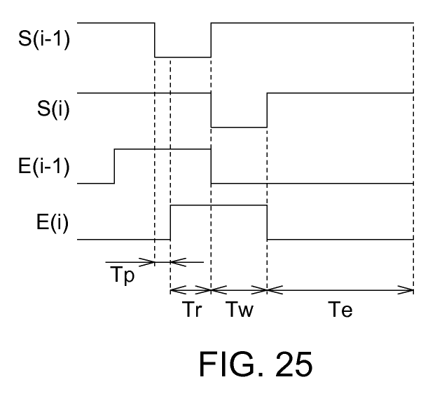

Referring to FIG. 24 and FIG. 25. FIG. 24 shows a detailed circuit diagram of a Pixel circuit according to a tenth embodiment of the invention. FIG. 25 shows a signal timing sequence diagram relating to the Pixel circuit 420 of FIG. 24. The Pixel circuit 420 of the present embodiment of the invention is different from the Pixel circuit 410 of the ninth embodiment in that the drains of the transistors M12′ and M13′ receive a reference voltage Vref instead of a low potential reference voltage VSS, and that the data voltage Vin′ inputted via the transistor M11 is equal to the data voltage Vdata but is not equal to the difference (Vdata−VOLEDi).

Thus, like the Pixel circuit 400 of the eighth embodiment, the Pixel circuit 420 of the present embodiment of the invention can also correspondingly compensate the variation of the threshold turn-on voltages of the driving transistor (that is, the transistor M17) and the OLED element.

The Pixel circuit of the above embodiments of the invention comprises an OLED unit and a driving transistor. The Pixel circuit of the above embodiments of the invention has the following features: The data voltage relating to the initial threshold turn-on voltage of the OLED element is recorded to the first storage element by a write unit. The threshold voltages of the driving transistor and the OLED unit are recorded to the second storage element by a pre-write unit. A compensated drive voltage is provided by a loop transistor according to the threshold voltage and the data voltage for enabling the driving transistor to drive the OLED unit. The compensated drive voltage compensates the variation of the threshold voltages of the driving transistor and the OLED unit. Thus, in comparison to the conventional OLED technology, the Pixel circuit of the above embodiments of the invention has the advantage of compensating the variation of the threshold voltages of the driving transistor and the OLED unit.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pixel circuit, comprising:
a driving transistor comprising a control end, a first connection end and a second connection end;
an electroluminescent unit coupled to the first connection end of the driving transistor and controlled by the driving transistor to illuminate in a drive period;
a write unit coupled to the driving transistor, wherein the write unit comprises a first storage element, and is enabled in a write period to record a data voltage between a first end and a second end of the first storage element; and
a pre-write unit coupled to the control end of the driving transistor and the write unit, wherein the pre-write unit comprises a second storage element, and is enabled in a pre-write period to record a threshold voltage, which is related to the threshold turn-on voltages of the electroluminescent unit and the driving transistor, between a first end and a second end of the second storage element, wherein,
the first and the second storage elements respectively have the threshold voltage and the data voltage applied between the control end and the first connection end of the driving transistor, so as to provide a compensated drive voltage for enabling the driving transistor to drive the electroluminescent unit and compensating the variation of the threshold voltages of the driving transistor and the electroluminescent unit.

2. The pixel circuit according to claim 1, wherein the pre-write unit further comprises:
a first transistor enabled by a previous-stage scanning signal in the pre-write period, so as to provide a first reference voltage to the second end of the second storage element; and
a second transistor enabled by the previous-stage scanning signal in the pre-write period, so as to connect the control end and the second connection end of the driving transistor, wherein the first end of the second storage element is discharged via the second transistor, the driving transistor and the electroluminescent unit, such that the second storage element correspondingly stores the threshold voltage.

3. The pixel circuit according to claim 2, wherein a gate of the first transistor receives a previous-stage scanning signal, a source of the first transistor receives a first reference voltage, and a drain of the first transistor is coupled to the second end of the second storage element, and a gate of the second transistor receives a previous-stage scanning signal, a drain of the second transistor is coupled to the second connection end of the driving transistor, and a source of the second transistor is coupled to the first end of the second storage element and the control end of the driving transistor.

4. The pixel circuit according to claim 2, wherein the threshold voltage corresponds to a sum of a threshold turn-on voltage of the electroluminescent unit and a threshold turn-on voltage of the driving transistor.

5. The pixel circuit according to claim 2, wherein the first reference voltage is equal to a ground level or a level half of that of an initial threshold turn-on voltage of the electroluminescent unit.

6. The pixel circuit according to claim 2, wherein the write unit further comprises:
a third transistor coupled to a data line and enabled by a current stage scan signal in the write period, so as to provide the data voltage to the first end of the first storage element;
a fourth transistor enabled by the current stage scan signal in the write period, so as to provide the first reference voltage to the second end of the first storage element, such that the first storage element correspondingly stores the data voltage.

7. The pixel circuit according to claim 1, wherein the pre-write unit further comprises:
a first transistor enabled by a previous-stage scanning signal in the pre-write period, so as to provide a first reference voltage to the second end of the second storage element; and
a second transistor enabled by the previous-stage scanning signal in the pre-write period, so as to connect the control end of the driving transistor and the first connection end, wherein the first end of the second storage element is discharged via the driving transistor and the electroluminescent unit, such that the second storage element correspondingly stores the threshold voltage.

8. The pixel circuit according to claim 7, wherein a gate of the first transistor receives a previous-stage scanning signal, a source of the first transistor receives a first reference voltage, and a drain of the first transistor is coupled to the second end of the second storage element, and a gate of the second transistor receives a previous-stage scanning signal, a drain of the second transistor is coupled to the first connection end of the driving transistor, and a source of the second transistor is coupled to the control end of the driving transistor.

9. The pixel circuit according to claim 7, wherein the threshold turn-on voltage corresponds to a sum of a threshold turn-on voltage of the electroluminescent unit and a threshold turn-on voltage of the driving transistor.

10. The pixel circuit according to claim 7, wherein the first reference voltage is equal to a ground level or a level half of that of an initial threshold turn-on voltage of the electroluminescent unit.

11. The pixel circuit according to claim 7, wherein the write unit further comprises:
a third transistor coupled to a data line and enabled by a current stage scan signal, so as to provide the data voltage to the first end of the first storage element in the write period;
a fourth transistor enabled by the current stage scan signal in the write period, so as to provide the first reference voltage to the second end of the first storage element, such that the first storage element correspondingly stores the data voltage.

12. The pixel circuit according to claim 1, wherein the write unit further comprises:
a third transistor coupled to a data line and enabled by a current stage scan signal in the write period, so as to provide the data voltage to the first end of the first storage element;
a fourth transistor enabled by the current stage scan signal in the write period, so as to provide a first reference voltage to the second end of the first storage element, which correspondingly stores the data voltage.

13. The pixel circuit according to claim 12, wherein a gate of the third transistor receives a current stage scan signal, a source of the third transistor is coupled to the first end of the first storage element, and a drain of the third transistor is coupled to the data line for receiving the data voltage, and a gate of the fourth transistor receives a current stage scan signal, a of the fourth transistor source receives a first reference voltage, and a drain of the fourth transistor is coupled to the second end of the first storage element.

14. The pixel circuit according to claim 12, wherein the first reference voltage is equal to a ground level or a level half of that of an initial threshold turn-on voltage of the electroluminescent unit.

15. The pixel circuit according to claim 1, further comprising:
a loop transistor, having a control end receiving one of a current-stage emission signal and a previous-stage emission signal, a first connection end coupled to the first connection end of the driving transistor, and a second connection end coupled to the second end of the first storage element.

16. The pixel circuit according to claim 15, wherein the electroluminescent unit comprises:
a first OLED element, having a first end coupled to the first connection end of the loop transistor, and a second end receiving a second reference voltage.

17. The pixel circuit according to claim 16, wherein the electroluminescent unit further comprises:
a second OLED element, having a first end coupled to the second connection end of the loop transistor, and a second end receiving the second reference voltage.

18. The pixel circuit according to claim 1, further comprising:
a loop transistor, having a control end receiving a previous-stage emission signal, and a first connection end coupled to the first connection end of the driving transistor.

19. The pixel circuit according to claim 18, wherein the electroluminescent unit comprises:
a first OLED element, having a first end coupled to the loop transistor and the first connection end of the driving transistor, and a second end receiving a second reference voltage.

20. The pixel circuit according to claim 19, wherein the electroluminescent unit further comprises:
a second OLED element, having a first end coupled to a second connection end of the loop transistor, and a second end receiving a second reference voltage.

21. The pixel circuit according to claim 1, further comprising:
a loop transistor having a control end receiving a current-stage emission signal, a first connection end coupled to the control end of the driving transistor, and a second connection end coupled to the second end of the first storage element.

22. The pixel circuit according to claim 21, wherein the electroluminescent unit comprises:
a first OLED element, having a first end coupled to a second connection end of the driving transistor, and a second end receiving a second reference voltage.

23. The pixel circuit according to claim 22, wherein the electroluminescent unit further comprises:
a switch transistor, having a control end receiving a current-stage emission signal, and a first connection end coupled to the second connection end of the driving transistor; and
a second OLED element, having a first end coupled to a second connection end of the switch transistor, and a second end receiving the second reference voltage.

24. The pixel circuit according to claim 1, further comprising:
a pre-charge unit for pre-charging the second storage element in a pre-charge period, before the pre-write unit records the threshold voltage, such that a third reference voltage is presented between the first end and the second end of the second storage element.

25. The pixel circuit according to claim 24, wherein the pre-charge unit comprises:
a fifth transistor enabled by a second-previous-stage scanning signal, so as to provide the third reference voltage to the first end of the second storage element.

26. The pixel circuit according to claim 1, further comprising:
a power supply unit for supplying a third reference voltage to the driving transistor in the drive period, such that the driving transistor is enabled for correspondingly driving the electroluminescent unit.

27. The pixel circuit according to claim 26, wherein the power supply unit comprises:
a sixth transistor enabled by a current-stage emission signal, so as to provide the third reference voltage to the first connection end of the driving transistor or a second connection end of the driving transistor.

28. The pixel circuit according to claim 26, wherein the power supply unit further pre-charges the second storage element before the pre-write unit records the threshold voltage, such that a third reference voltage is presented between the first end and the second end of the second storage element.

29. The pixel circuit according to claim 1, further comprising:
a level control unit for controlling a level at the first end of the second storage element according to the data voltage in the write period.

30. The pixel circuit according to claim 29, wherein the level control unit comprises:
a transistor having a gate receiving a current stage scan signal, a drain coupled to the data line for receiving the data voltage, and a source coupled to the first end of the second storage element.

31. The pixel circuit according to claim 1, wherein the data voltage relates to an initial threshold turn-on voltage of the electroluminescent unit.
